(19) United States
(12) Patent Application Publication
(10) Pub. No.: US 2012/0197446 A1
(43) Pub. Date: Aug. 2, 2012

(54) ADVANCED FEED-FORWARD VALVE-CONTROL FOR A MASS FLOW CONTROLLER

(76) Inventor: Stephen P. Glaudel, Lebanon, NJ (US)

(21) Appl. No.: 13/309,338

(22) Filed: Dec. 1, 2011

Related U.S. Application Data
(60) Provisional application No. 61/418,827, filed on Dec. 1, 2010.

(51) Int. Cl. G05D 7/06

(52) U.S. Cl. 700/282

(57) ABSTRACT

The disclosed embodiments include a method, apparatus, and computer program product for measuring and controlling gas and/or liquid flow. In particular, embodiments of the invention provide advanced feed-forward valve-control for a mass flow controller for placing a proportional control valve in its expected position in response to a change in customer set point and/or an inlet pressures. In addition, the disclosed embodiments also provide independent ‘corroboration’ of the measured flow by a thermal mass flow sensor.

### CROSS REFERENCE TO RELATED APPLICATIONS

This application claims the benefit of U.S. Provisional Application No. 61/418,827, filed on Dec. 1, 2010 in the name of inventors Stephen P. Glaudel and John Lull, titled “Advanced Feed-Forward Valve-Control for a Mass Flow Controller,” which is hereby incorporated by reference.

### BACKGROUND OF THE INVENTION

1. Field of the Invention

The present invention relates generally to methods and systems for determining the mass flow rate of a fluid, and more particularly to the operation of thermal mass flow controllers.

2. Discussion of the Related Art

Many industrial processes require precise control of various process fluids. For example, in the pharmaceutical and semiconductor industries, mass flow controllers are used to precisely measure and control the amount of a process fluid that is introduced to a process tool. A fluid can be any type of matter in any state that is capable of flow such as liquids, gases, and slurries, and comprising any combination of matter or substance to which controlled flow may be of interest.

Conventional mass flow controllers (MFCs) generally include four main portions: a flow meter, a control valve, a valve actuator, and a controller. The flow meter measures the mass flow rate of a fluid in a flow path and provides an electrical signal indicative of that flow rate. Typically, the flow meter may include a mass flow sensor and a bypass. The mass flow sensor measures the mass flow rate of fluid in a sensor conduit that is fluidly coupled to the bypass. The mass flow rate of fluid in the sensor conduit is related to the mass flow rate of fluid flowing in the bypass, with the sum of the two being the total flow rate through the flow path controlled by the mass flow controller.

One type of mass flow meter is a thermal mass flow meter that operates on the principle that as fluid passes through a sensor tube, a heat is imparted to the fluid. Then, two temperature measurements are made of the fluid, one ‘upstream’ and one ‘downstream’. As fluid picks-up heat in the tube, the flow of that fluid will increase the downstream temperature compared to the upstream temperature, which is often measured using an electronic ‘bridge’ circuit. The effect is that the electronic signal is roughly linearly proportional to the flowrate.

The disclosed embodiments recognize and provide solutions to certain problems associated with the current use of thermal mass flow meters in a mass flow controller.

### SUMMARY OF THE INVENTION

An object of the invention is to provide advanced feed-forward valve-control for a mass flow controller for measuring and controlling gas and/or liquid flow to a semiconductor processing chamber and/or other related utilities. Another object of the invention is to provide independent ‘corroboration’ of the measured flow by a thermal mass flow sensor.

In accordance with one embodiment, a thermal mass flow controller for measuring and controlling fluid flow is disclosed. The thermal mass flow controller includes a thermal mass flow meter for providing a signal corresponding to mass flow through the flow meter and an adjustable valve for controlling the passage of fluid out of the mass flow controller. The thermal mass flow controller also includes at least one processor configured to determine an expected valve position in response to at least one of a change in set point and inlet pressure, wherein the expected valve position is not based on the signal provided by the thermal mass flow meter. The thermal mass flow controller has a controller to adjust the adjustable valve to the expected valve position to control the flow through the mass flow controller.

In another embodiment, a method for a controlling a thermal mass flow controller is disclosed. The method includes calculating an expected valve position in response to at least one of a change in set point and inlet pressure, wherein the expected valve position is not based on a signal provided by a thermal mass flow meter of the thermal mass flow controller. The method adjusts an adjustable valve to the expected valve position to control flow through the mass flow controller.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures for carrying out the same purposes of the present invention.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 illustrates a thermal mass flow controller in accordance with a disclosed embodiment;

FIG. 2 illustrates a schematic block diagram of a mass flow in accordance with a disclosed embodiment;

FIG. 3 illustrates a process for providing advanced feed forward valve control and independent corroboration of a thermal mass flow meter in accordance with a disclosed embodiment;

FIGS. 4-6 illustrate charts depicting valve-characteristics generated for a proportional solenoid valve in accordance with a disclosed embodiment; and

FIG. 7 illustrates a process for determining an expected valve position in accordance with a disclosed embodiment; and

FIG. 8 depicts several diagrams illustrating magnetic hysteresis.

### DETAILED DESCRIPTION OF PREFERRED EMBODIMENTS

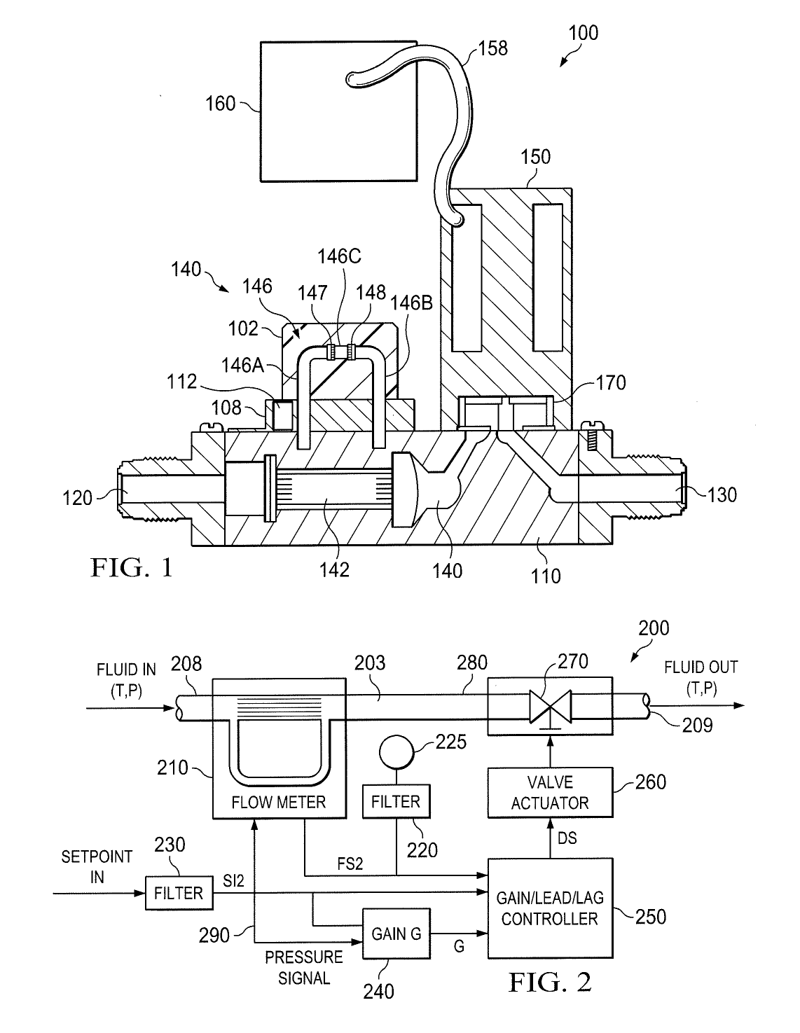

FIG. 1 shows schematically an embodiment of a mass flow controller 100 that includes a block 110, which is the platform on which the components of the MFC are mounted. A thermal mass flow meter 140 and a valve assembly 150 containing a valve 170 are mounted on the block 110 between a fluid inlet 120 and a fluid outlet 130. The thermal mass flow meter 140 includes a bypass 142 through which typically a majority of fluid flows and a sensor 146 through which a smaller portion of the fluid flows.

Sensor 146 is contained within a sensor housing 102 (portion shown removed to show sensor 146) mounted on a mounting plate or base 108. Sensor 146 is a small diameter tube, typically referred to as a capillary tube, with a sensor inlet portion 146A, a sensor outlet portion 146B, and a sensor measuring portion 146C about which two resistive coils or windings 147 and 148 are disposed. In operation, electrical current is provided to the two resistive windings 147 and 148, which are in thermal contact with the sensor measuring portion 146C. The current in the resistive windings 147 and 148 heats the fluid flowing in measuring portion 146 to a temperature above that of the fluid flowing through the bypass 142. The resistance of windings 147 and 148 varies with temperature. As fluid flows through the sensor conduit, heat is carried from the upstream resistor 147 toward the downstream resistor 148, with the temperature difference being proportional to the mass flow rate through the sensor.

An electrical signal related to the fluid flow through the sensor is derived from the two resistive windings 147, 148. The electrical signal may be derived in a number of different ways, such as from the difference in the resistance of the resistive windings or from a difference in the amount of energy provided to each resistive winding to maintain each winding at a particular temperature. Examples of various ways in which an electrical signal correlating to the flow rate of a fluid in a thermal mass flow meter may be determined are described, for example, in commonly owned U.S. Pat. No. 6,845,659, which is hereby incorporated by reference. The electrical signals derived from the resistive windings 147,148 after signal processing comprise a sensor output signal.

The sensor output signal is correlated to mass flow in the mass flow meter so that the fluid flow can be determined when the electrical signal is measured. The sensor output signal is typically first correlated to the flow in sensor 146, which is then correlated to the mass flow in the bypass 142, so that the total flow through the flow meter can be determined and the control valve 170 can be controlled accordingly. The correlation between the sensor output signal and the fluid flow is complex and depends on a number of operating conditions including fluid species, flow rate, inlet and/or outlet pressure, temperature, etc.

The process of correlating raw sensor output to fluid flow entails tuning and/or calibrating the mass flow controller and is an expensive, labor intensive procedure, often requiring one or more skilled operators and specialized equipment. For example, the mass flow sensor may be tuned by running known amounts of a known fluid through the sensor portion and adjusting certain signal processing parameters to provide a response that accurately represents fluid flow. For example, the output may be normalized, so that a specified voltage range, such as 0 V to 5 V of the sensor output, corresponds to a flow rate range from zero to the top of the range for the sensor. The output may also be linearized, so that a change in the sensor output corresponds linearly to a change in flow rate. For example, doubling of the fluid output will cause a doubling of the electrical output if the output is linearized. The dynamic response of the sensor is determined, that is, inaccurate effects of change in pressure or flow rate that occur when the flow or pressure changes are determined so that such effects can be compensated.

A bypass may then be mounted to the sensor, and the bypass is tuned with the known fluid to determine an appropriate relationship between fluid flowing in the mass flow sensor and the fluid flowing in the bypass at various known flow rates, so that the total flow through the flow meter can be determined from the sensor output signal. In some mass flow controllers, no bypass is used, and the entire flow passes through the sensor. The mass flow sensor portion and bypass may then be mated to the control valve and control electronics portions and then tuned again, under known conditions. The responses of the control electronics and the control valve are then characterized so that the overall response of the system to a change in set point or input pressure is known, and the response can be used to control the system to provide the desired response.

When the type of fluid used by an end-user differs from that used in tuning and/or calibration, or when the operating conditions, such as inlet and outlet pressure, temperature, range of flow rates, etc., used by the end-user differ from that used in tuning and/or calibration, the operation of the mass flow controller is generally degraded. For this reason, the flow meter can be tuned or calibrated using additional fluids (termed “surrogate fluids”) and or operating conditions, with any changes necessary to provide a satisfactory response being stored in a lookup table. U.S. Pat. No. 7,272,512 issued to Wang et al., for “Flow Sensor Signal Conversion,” which is owned by the assignee of the present invention and which is hereby incorporated by reference, describes a system in which the characteristics of different gases are used to adjust the response, rather than requiring a surrogate fluid to calibrate the device for each different process fluid used.

Control electronics 160 control the position of the control valve 170 in accordance with a set point indicating the desired mass flow rate, and an electrical flow signal from the mass flow sensor indicative of the actual mass flow rate of the fluid flowing in the sensor conduit. Traditional feedback control methods such as proportional control, integral control, proportional-integral (PI) control, derivative control, proportional-derivative (PD) control, integral-derivative (ID) control, and proportional-integral-derivative (PID) control are then used to control the flow of fluid in the mass flow controller. A control signal (e.g., a control valve drive signal) is generated based upon an error signal that is the difference between a set point signal indicative of the desired mass flow rate of the fluid and a feedback signal that is related to the actual mass flow rate sensed by the mass flow sensor. The control valve is positioned in the main fluid flow path (typically downstream of the bypass and mass flow sensor) and can be controlled (e.g., opened or closed) to vary the mass flow rate of fluid flowing through the main fluid flow path, the control being provided by the mass flow controller.

In the illustrated example, the flow rate is supplied by electrical conductors 158 to a closed loop system controller 160 as a voltage signal. The signal is amplified, processed and supplied to the control valve assembly 150 to modify the flow. To this end, the controller 160 compares the signal from the mass flow sensor 140 to predetermined values and adjusts the proportional valve 170 accordingly to achieve the desired flow.

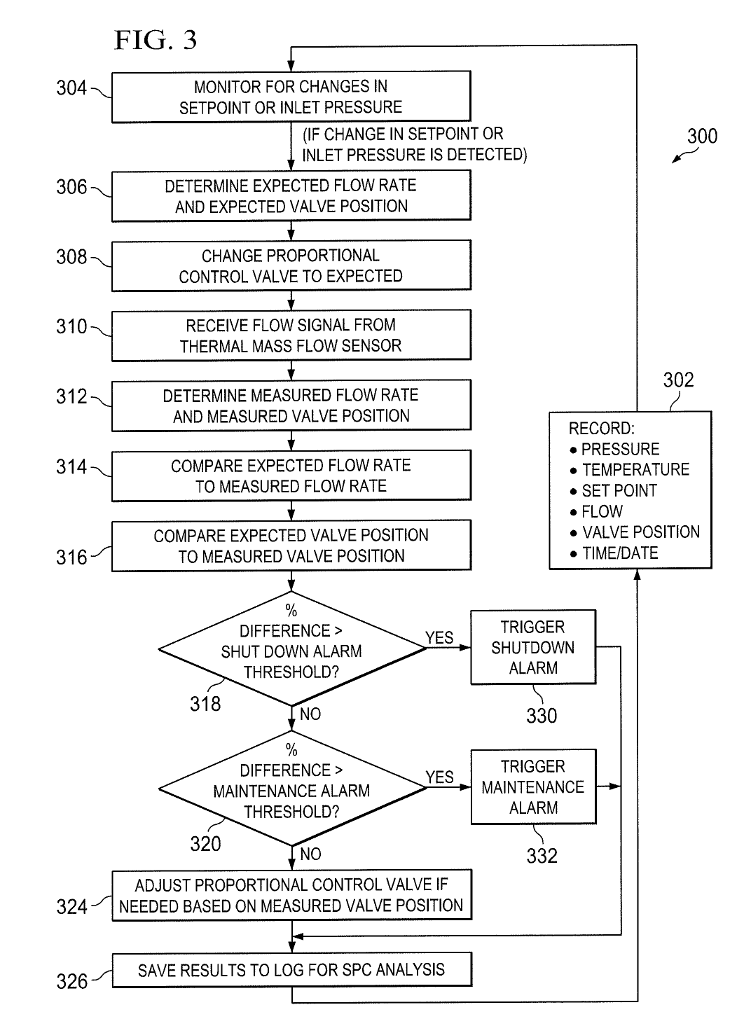

FIG. 2 illustrates a schematic block diagram of a typical mass flow controller 200. The mass flow controller illustrated in FIG. 2 includes a thermal mass flow meter 210, a Gain/Lead/Lag (GLL) controller 250, a valve actuator 260, and a valve 270.

The thermal mass flow meter 210 is coupled to a flow path 203. The thermal mass flow meter 210 senses the flow rate of a fluid in the flow path, or in a portion of the flow path, and provides a raw flow signal indicative of the sensed flow rate. The raw flow signal is typically conditioned, that is, it is normalized, linearized, and compensated for dynamic response. A conditioned flow signal FS2 is provided to a first input of GLL controller 250. The conditioned flow signal FS2 is also provided to a signal filter 220, which provides appropriate signal levels as input to a display 225, which displays the flow rate to an operator.

In addition, GLL controller 250 includes a second input to receive a set point signal SI2. A set point refers to an indication of the desired fluid flow to be provided by the mass flow controller 200. The set point signal SI2 may first be passed through a slew rate limiter or filter 230 prior to being provided to the GLL controller 250. Filter 230 serves to limit instantaneous changes in the set point in signal SI2 from being provided directly to the GLL controller 250, such that changes in the flow take place over a specified period of time. It should be appreciated that the limiter or filter 230 may be omitted, and that any of a variety of signals capable of providing indication of the desired fluid flow is considered a suitable set point signal. The term set point, without reference to a particular signal, describes a value that represents a desired fluid flow.

Each of the components of MFC 200 has an associated gain, which gains can be combined to determine a system gain. In block 240, a reciprocal gain term G is formed by taking the reciprocal of a system gain term and applying it as one of the inputs to the GLL controller. It should be appreciated that the reciprocal gain term may be the reciprocal of all or fewer than all of the gain terms associated with the various components around the control loop of the mass flow controller. For example, improvements in control and stability may be achieved by forming the reciprocal of the product of the individual component gain terms. However, in preferred embodiments, gain term G is formed such that the loop gain remains a constant (i.e., gain G is the reciprocal of the system gain term).

Pressure sensed at the inlet 208 or elsewhere provides a pressure signal 290 to thermal mass flow meter 210 to compensate for spurious indications due to pressure transients. Further, the pressure signal may be used by GLL controller 250 for feed forward control of the valve. Also, the pressure signal may be used to adjust the gain in a GLL controller.

Based in part on the flow signal from the thermal mass flow meter 210 and the set point signal SI2, the GLL controller 250 provides a drive signal DS to the valve actuator 260 that controls the valve 270. The valve 270 is typically positioned downstream from the thermal mass flow meter 210 and permits a certain mass flow rate depending, at least in part, upon the displacement of a controlled portion of the valve 270. The controlled portion of the valve 270 may be a moveable plunger placed across a cross-section of the flow path 203. The valve 270 controls the flow rate in the fluid path by increasing or decreasing the area of an opening in the cross section where fluid is permitted to flow. Typically, mass flow rate is controlled by mechanically displacing the controlled portion of the valve by a desired amount. The term displacement is used generally to describe the variable of a valve on which mass flow rate is, at least in part, dependent. As such, the area of the opening in the cross section is related to the displacement of the controlled portion, referred to generally as valve displacement.

The displacement of the valve is often controlled by a valve actuator, such as a solenoid actuator, a piezoelectric actuator, a stepper actuator etc. In FIG. 2, valve actuator 260 is a solenoid type actuator; however, the present invention is not so limited, as other alternative types of valve actuators may be used. The valve actuator 260 receives drive signal DS from the controller and converts the signal DS into a mechanical displacement of the controlled portion of the valve. Ideally, valve displacement is purely a function of the drive signal. However, in practice, there may be other variables that affect the position of the controlled portion of the valve.

When the input pressure changes, for a brief period of time the sensor output does not accurately indicate the mass flow. To mitigate this effect, some mass flow controllers include a pressure transducer. Pressure transducers allow tuning of the dynamic response of the device as a function of pressure, which in turn can provide a faster response, especially at low inlet pressures. For example, U.S. Pat. No. 7,273,063 to Lull et al., which is commonly owned with the present application and which is hereby incorporated by reference, uses signals from a pressure transducer to modify the sensor signal to compensate for some pressure related transient effects and provides some compensation for changes in the amount of gas in the inventory volume.

One problem with thermal mass flow controllers is that the response time of a thermal mass flow sensor to generate the electronic signal indicating a measured flow is in the order of ‘seconds’ due to the fact that thermal flow sensors are mounted over a rather ‘large’ tube. Therefore, because the thermal mass flow controller relies on the electronic signal generated by the thermal mass flow sensor to adjust the valve position, the response time of the thermal mass flow controller in adjusting the valve position is delayed.

Another problem with thermal mass flow controllers is that thermal mass flow sensors tend to ‘drift’ over time. For example, the value measured at a constant flow is different now versus one month ago. This can be caused by process conditions (e.g. the ‘fouling’ of the customer fluid onto the walls of the sensor tube, thus affecting its heat-transfer characteristics) or for manufacturing reasons.

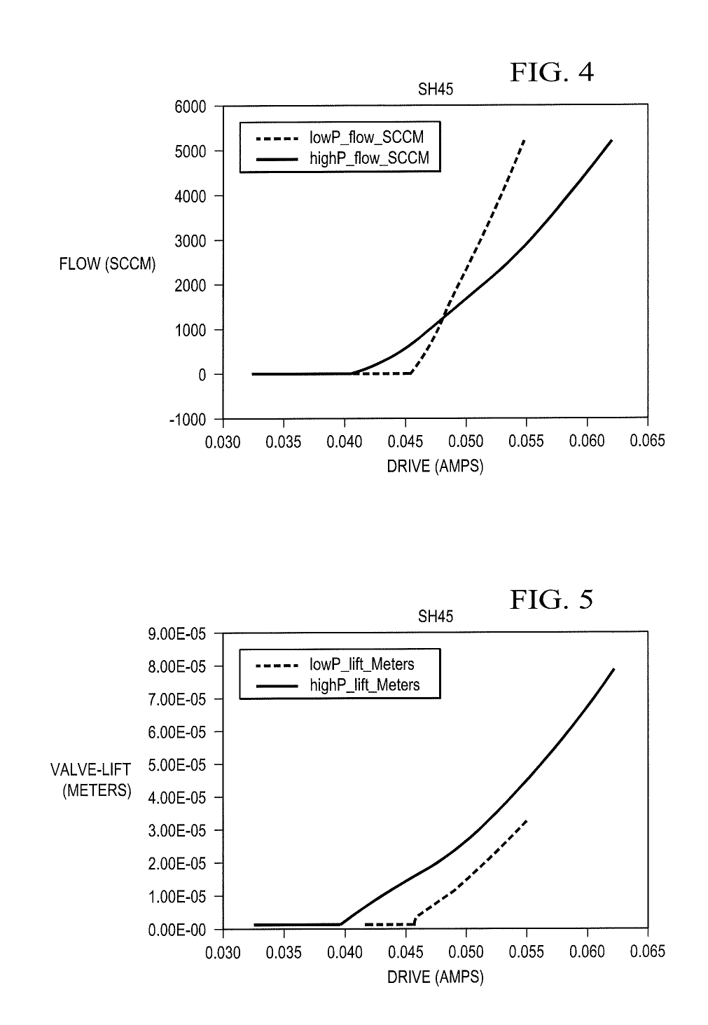

FIG. 3 depicts an embodiment of a process 300 that decreases the time it takes for a to thermal mass flow controller to adjust the valve position in response to a change in a customer set point or in response to a change in inlet pressure. Process 300 also determines and alerts a user when a thermal mass flow sensor has drifted beyond a desired threshold.

Process 300 begins at step 302 by recording a plurality of characteristics for a thermal mass flow controller including pressure, temperature, set point, flow, and valve position. In one embodiment, the characteristics are generated by subjecting a proportional solenoid valve of a thermal mass flow controller to a valve-characterization station (VCS), which produces data tables for a multitude of flow rates at a multitude of pressures.

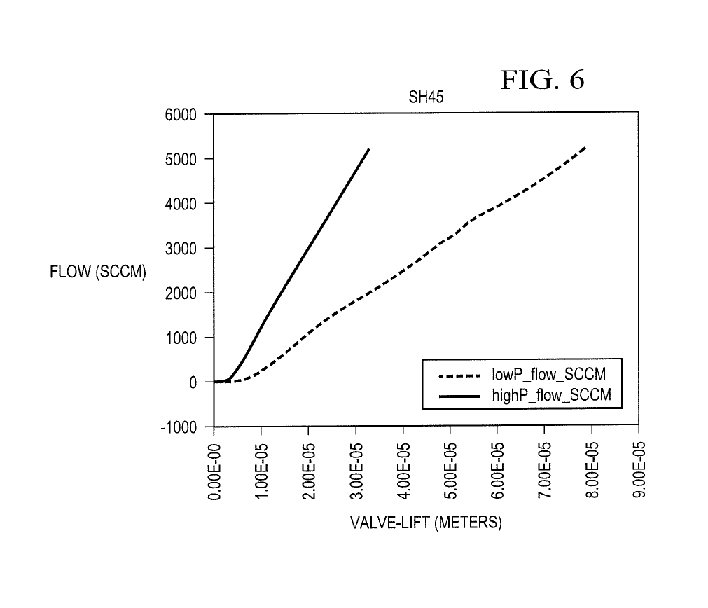

Examples of valve characterization data generated at the valve-characterization station are depicted in the charts in FIGS. 4-6. FIG. 4 depicts the characteristics of the flow in standard cubic centimeters per minute (sccm) versus drive (amps) of a proportional solenoid valve for both low and high flow. FIG. 5 depicts the characteristics of valve lift (meters) versus drive (amps) of a proportional solenoid valve for both low and high flow. FIG. 6 depicts the characteristics of the flow (sccm) versus valve lift (meters) of a proportional solenoid valve for both low and high flow. The valve characterization data is stored in memory of a thermal mass flow controller.

At step 304, the process monitors for changes in set point or inlet pressure. A change in set point occurs when a user of the thermal mass flow controller adjusts the set point indicating a desired mass flow rate. A change inlet pressure may be detected using a pressure transducer to measure pressure at or about the inlet of the thermal mass flow controller. Changes in inlet pressure may occur due to fluctuations in fluid flow.

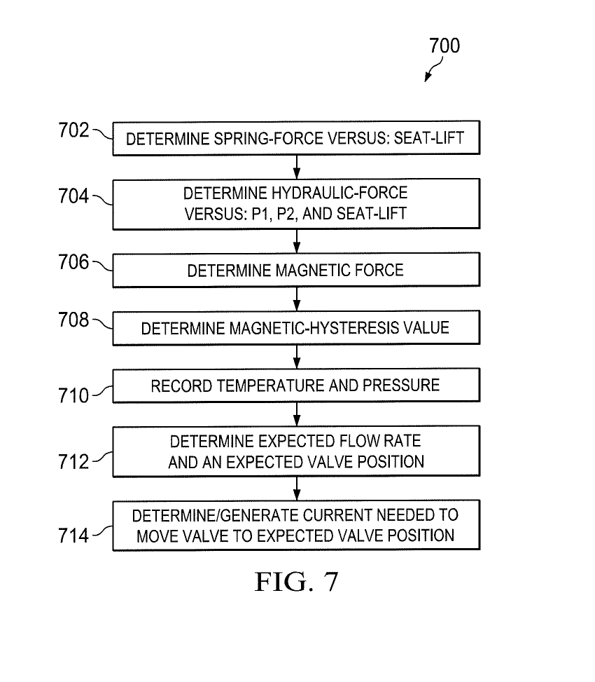

In response to detecting a change in set point or inlet pressure, the process determines an expected flow rate and an expected valve position at step 306. As an example, one method for determining an expected flow rate and an expected valve position is depicted in FIG. 7. As will be further described, additional methods for determining an expected flow rate and an expected valve position may be contemplated and used with the disclosed embodiment.

Using the determined expected valve position, the process, at step 308, determines and generates the valve drive current needed to place the proportional control valve in the expected valve position. As a result, the disclosed embodiment is able to place the proportional control valve in an expected valve position before receiving the flow signal from the thermal mass flow sensor at step 310.

In addition, after receiving the flow signal from the thermal mass flow sensor, the process determines a measured flow rate and a measured valve position based on the flow signal from the thermal mass flow sensor at step 312. The process at step 314 compares the calculated expected flow rate to the measured flow rate. Thus, the calculated expected flow rate can then be used to corroborate the flow rate generated by the thermal mass flow sensor. Although not depicted in FIG. 3, an alarm may be triggered if the difference between the expected flow rate and the measured flow rate exceeds a specified threshold.

Similarly, the process, at step 316, may compare the determined expected valve position to the measured valve position. At step 318, the process determines whether a percent difference between the determined expected valve position and the measured valve position is greater than a shutdown alarm threshold (i.e., a threshold in which the device should be taken off-line). If the process determines that the percent difference between the determined expected valve position and the measured valve position is greater than a shutdown alarm threshold, the process triggers a shutdown alarm at step 330.

If the shutdown alarm is not triggered, the process, at step 320, may also determine whether the percent difference between the determined expected valve position and the measured valve position is greater than a maintenance alarm threshold (i.e., a threshold in which maintenance on the device should be performed at a convenient time). In certain embodiments, the shutdown alarm threshold and/or the maintenance alarm threshold are customer configurable options. The process triggers the maintenance alarm at step 332 in response to a determination that the percent difference between the calculated expected valve position and the actual valve position is greater than a maintenance alarm threshold.

Further, the process may adjust the proportional control valve, if needed, from the determined expected valve position to the measured valve position at step 324. Even if an adjustment is needed, the difference between the expected valve position to the measured valve position is most likely less than the difference between the original valve position and the measured valve position, thus, the disclosed embodiment is able to place the proportional control valve to the measured valve position sooner than if no prior adjustment had been made. The process saves the results to a log for Statistical Process Control (SPC) analysis at step 326 and repeats process 300.

Referring back to step 306, reference is now made to process 700 illustrated in FIG. 7, depicting an embodiment for determining an expected flow rate and an expected valve position using a mathematical-multivariable-model developed for valve-position/stroke. Process 700 uses the valve-characterization station (VCS) data tables recorded at step 302 to derive an empirical relationship between: magnetic-force, coil-milliamps, and air-gap/seat-lift.

Process 700 begins at step 702 by determining spring-force versus seat-lift. In the mass flow controller, a spring applies force to plunger to force it down to valve seat. The spring force may be determined by the equation: spring force=spring rate×displacement. The spring rate is a constant that depends on the spring's material and construction. The displacement can be determined to by measuring the distance the spring is deformed when the valve is closed.

At step 704, the process determines hydraulic-force versus: P1, P2, and seat-lift. P1 and P2 are the inlet pressure and the outlet pressure. The process determines the change in pressure between the inlet and outlet pressure by measuring the upstream pressure using a pressure sensor and assumes that the downstream pressure is zero. The process multiplies the change in pressure by the area (Pi×r²) to determine hydraulic force in comparison to seat lift.

The process then determines magnetic force (i.e., the force exerted on the plunger by the solenoid in order to move the valve) at step 706. In one embodiment, the process determines magnetic force for both pressure-over the seat and pressure-under the seat. The process calculates the force based on the assumption that magnetic flux is perpendicular to the surface of the plunger and that it is confined to a particular area. The magnetic flux through the surface of the plunger is proportional to the number of magnetic B field lines that pass through the surface of the plunger.

As part of determining the magnetic force, at step 708, the process determines a magnetic-hysteresis value to compensate for magnetic-hysteresis of the valve using a mathematical magnetic hysteresis model that is part of the stored data and instructions on the mass flow controller. Magnetic-hysteresis causes a lag between input and output due to residual magnetization in the valve. The characteristics of the model are collected during the VCS steps as described above. The model accounts for the hysteresis effect on the valve position as the valve drive changes over time.

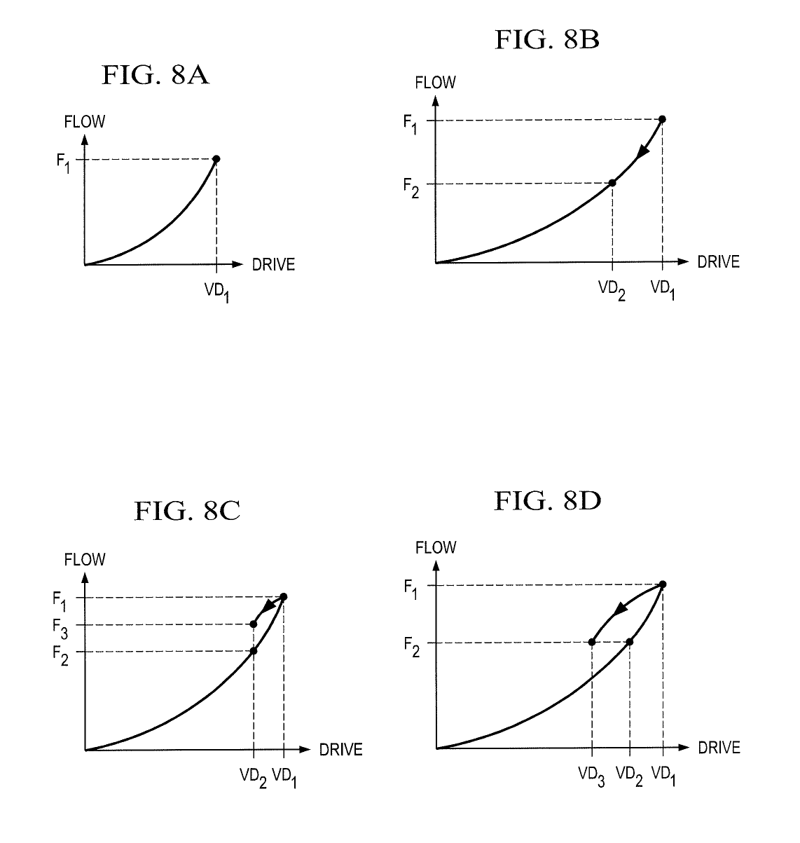

For instance, referring to FIG. 8, in a non-hysteresis model, changes in valve drive are expected to be reflected in the valve position independently of the history of the valve drive (see FIG. 8A). In FIG. 8B, a change in setpoint from a flow F1 to a Flow F2 is expected to require a change in valve drive from Vd1 to VD2. However, due to the magnetic hysteresis effect, changing the valve drive from Vd1 to Vd2 results in a different flow F3 as shown FIG. 8C. In order to attain the correct flow F2, the valve drive needs to be changed to the position VD3 as in FIG. 8D. Using the hysteresis based mathematical model, the process would predict the required position for flow F2 (e.g., VD3) as shown as in FIG. 8D. The process commands the controller in the mass flow controller to use the GLL control block as shown in FIG. 2 to move the valve drive to VD3 to attain the desired flow F2.

Once magnetic force is determined, the process, at step 710, measures and records the inlet pressure and temperature using an accurate pressure transducer and temperature sensor. Using the above calculations, pressure and temperature readings, and the stored VCS data, which provides data regarding flow versus lift, the process at step 712 determines an expected flow rate and an expected valve position for the new set point or changed inlet pressure under the assumption that the outlet pressure is ‘close’ to vacuum (as is the case in the majority of circumstances in the semiconductor market). For instance, the process may perform a data table lookup of known flow rates versus ‘stroke’ at specified temps and pressures in determining the expected flow rate and the expected valve position.

Finally, the process at step 714 determines and generates the amount of current needed to the move the valve to the expected valve position based on the determined magnetic force.

As discussed above, magnetic force is determined using a mathematical model, which includes a mathematical magnetic hysteresis model for compensating for magnetic hysteresis.

In an alternative embodiment, magnetic force may be derived magnetically from the valve itself. This embodiment utilizes a measurement of the inductance of the solenoid coil as a very good proxy for the air-gap of the solenoid, which is directly linear with the valve stroke as the plunger/core approaches the plugnut/polepiece. This embodiment provides a more accurate determination of the valve-stroke position. Therefore, if there is any sensor-vs.-valve discrepancy, then the discrepancy likely indicates a problem with the sensor (e.g. clogging, coating, inadequate Cp data).

To relate inductance to magnetic-fields to air-gap, the second embodiment uses the following equations for determining Magnetic-force across an Air-Gap. Under the assumption that there is mostly non-fringing fields or at least a reproducible pattern of fringing, then Magnetic-force across an Air-Gap=B-field²*Air-Gap-Area/(2*Mu-0). Alternatively, a second equation for determining Magnetic-force across an Air-Gap is Magnetic-force across an Air-Gap=MMF2*Mu-0*Air-Gap-Area/(2*Air-Gap-distance2), where MMF=‘magneto-motive-force’˜=N*I.

By replacing MMF with N*I in the above equation, Magnetic-force is roughly-proportional to the square of: N*I/Air-Gap-distance, where Mu-0 and Air-Gap-Area are constants (referred to below as equation A).

The second embodiment then relies on the formula for inductance (L), L=Phi*N/I, where Phi (“magnetic flux”)=B-field*Area. Substituting Phi in the inductance formula, L=B-field*Area*N/I. Solving for B-field, then B-field=(L*I)/(A*N).

The second embodiment then substitutes the above formula for B-field, into the first equation Magnetic-force across an Air-Gap. Thus, yielding the equation Magnetic-force across an Air-Gap=((L*I)/(Area*N))²*Air-Gap-Area/(2*Mu-0), which equals (L2*I2)/(Area*2*Mu-0*N2). Therefore, if Mu-0 and Air-Gap-Area are constants, then Magnetic-force is roughly-proportional to the square of: L*I/N (referred to below as equation B).

By combining equation A, wherein Magnetic-force is roughly-proportional to the square of: N*I/Air-Gap-distance, with equation B, wherein Magnetic-force is roughly-proportional to the square of: L*I/N, the second embodiment determines that inductance (L) is roughly-proportional to: N²/Air-Gap-distance for a given current.

Thus, by directly measuring inductance, the disclosed embodiment can estimate Air-Gap distance using the above formula. To measure inductance of an analog coil driver, an AC current (e.g. 0.1 mA at 1 kHz) imposed onto the solenoid ‘dc’ drive and then a bandpass filter is used to capture coil-voltage at that same frequency. Alternatively, inductance may be measured by phase-shifting (theta) of a superimposed high-frequency. For example, Tangent(theta)=j*2*pi*freq*L/R, then Tangent(theta) is prop to L (w/constant R). Both embodiments provide an extremely rapid way of measuring inductance.

Using the estimated Air-Gap distance, the second embodiment performs a data table lookup using the VCS data to correlate the estimated Air-Gap distance to ‘valve-stroke’ for determining an expected valve position. Similarly, using the VCS data, the second embodiment may perform a data table lookup to correlate the expected valve position to an expected flow rate for use in corroborating the flow rate measurement produced by the thermal mass flow sensor.

Accordingly, the above disclosure describes several embodiments for providing an advanced feed-forward valve-control and a corroboration mechanism for a thermal mass flow controller. The disclosed embodiments can quickly determine an expected flow rate and an expected valve position in response to a new set point or a change in inlet pressure so as to place the proportional valve in an expected position without having to wait for the intrinsically slow thermal sensor. The disclosed embodiments can then monitor the flow measurement from the thermal mass flow sensor to ensure accuracy and to alarm/alert the tool-controller upon any potential inaccuracy. Therefore, the disclosed embodiments provide solutions to the problems of slow response time and the lack of independent corroboration of a thermal mass flow sensor associated with current use the thermal mass flow controllers.

While the above description may describe a particular sequence of steps, the disclosed embodiments are not intended to be limited to any particular arrangement or sequence of steps as some of the steps may be performed in a different sequence and/or in parallel.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, or transport the program for use by or in connection with the instruction execution system, apparatus, or device. The previous detailed description discloses several embodiments for implementing the invention and is not intended to be limiting in scope. Those of ordinary skill in the art will recognize obvious variations to the embodiments disclosed above and the scope of such variations are intended to be covered by this disclosure. The following claims set forth the scope of the invention.

Although the present invention and its advantages have been described in detail, it should be understood that various changes, substitutions and alterations can be made herein without departing from the spirit and scope of the invention as defined by the appended claims. For example, while the embodiment described above compensates for input pressure transients, skilled persons can recognize that embodiments could also compensate for changes in output pressure in the case of devices wherein the flow meter is not substantially isolated from the output pressure by action of the control valve (e.g. in a reverse flow device having the control valve upstream of the flow meter). Moreover, the scope of the present application is not intended to be limited to the particular embodiments of the process, machine, manufacture, composition of matter, means, methods and steps described in the specification. For example, both pressure and temperature are required for calculations of the preferred embodiments. The pressure measurement used can be obtained, for instance, directly from inlet pressure, from a transducer exposed directly to the inventory volume, or approximated. Similarly, the temperature measurement used can be obtained, for instance, from the flow sensor body temperature or average gas temperature in the inventory volume. The invention is not limited to any particular means for generating an electrical signal corresponding to the flow. While an embodiment using two resistive coils is described, other embodiments can use three or any number of resistive coils, or other temperature sensitive elements, such as thermocouples or thin film resistors. Also, the invention is not limited to mass flow meters, but could be applied to other types of flow meters, such as volume flow meters.

While the inventory volume was described in the embodiment above as comprising the volume between the flow sensor and the adjustable valve, the inventory volume could comprise any volume between the flow sensor and a flow restriction, such as an orifice. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A thermal mass flow controller for measuring flow of a fluid, comprising:
a thermal mass flow meter for providing a signal corresponding to mass flow through the flow meter, the flow meter including a flow sensor;
an adjustable valve for controlling the passage of fluid out of the mass flow controller;
a fluid path through the mass flow controller;
a pressure transducer for providing a signal corresponding to the fluid pressure at an inlet of the flow path; and
at least one processor configured to determine an expected valve position in response to at least one of a change in set point and inlet pressure, wherein the expected valve position is not based on the signal provided by the thermal mass flow meter; and
a controller to adjust the adjustable valve to the expected valve position to control the flow through the mass flow controller.

2. The mass flow controller of claim 1, wherein the at least one processor is configured to determine the expected valve position using a mathematical model of the valve involving a multivariable function.

3. The mass flow controller of claim 1, wherein the at least one processor is configured to magnetically derive a magnetic force from the adjustable valve itself.

4. The mass flow controller of claim 3, wherein the at least one processor is configured to measure the inductance of a solenoid coil of mass flow controller.

5. The mass flow controller of claim 4, wherein measuring the inductance of the solenoid coil is performed by imposing an AC current onto the solenoid ‘dc’ drive and capturing coil-voltage at a same frequency using a bandpass filter.

6. The mass flow controller of claim 4, wherein measuring the inductance of the solenoid coil is performed by phase-shifting (theta) of a superimposed high-frequency.

7. The mass flow controller of claim 4, wherein the at least one processor is further configured to determine a direct-measure of magnetic Air-Gap using the measured inductance.

8. The mass flow controller of claim 3, wherein the derived magnetic force is used to determine a flow rate.

9. The mass flow controller of claim 8, wherein the at least one processor is further configured to compare the determined flow rate to a second flow rate generated by the thermal mass flow meter.

10. The mass flow controller of claim 1, wherein the controller further adjusts the adjustable valve from the expected valve position to a second valve position based on the signal corresponding to mass flow provided by the thermal mass flow meter.

11. The mass flow controller of claim 10, wherein the at least one processor is further configured to:
determine a difference value between the expected valve position and the second valve position;
compare the difference value to a shutdown alarm threshold value; and
trigger a shutdown alarm in response to the difference value being greater than the shutdown alarm threshold value.

12. The mass flow controller of claim 10, wherein the at least one processor is further configured to:
determine a difference value between the expected valve position and the second valve position;
compare the difference value to a maintenance alarm threshold value; and
trigger a maintenance alarm in response to the difference value being greater than the shutdown maintenance threshold value.

13. The mass flow controller of claim 1 further comprising memory for storing valve characteristic data produced by subjecting the adjustable valve to a multitude of flow rates and pressures.

14. The mass flow controller of claim 13, wherein the at least one processor uses the stored valve characteristic data in determining the solenoid current for the expected valve position.

15. The mass flow controller of claim 2, wherein the multivariable function assumes that the outlet pressure is ‘close’ to vacuum in determining the solenoid current for the expected valve position.

16. The mass flow controller of claim 2, wherein the multivariable function derives a relationship between magnetic-force, coil-milliamps, and air-gap/seat-lift.

17. A method for a controlling a thermal mass flow controller, comprising:
calculating an expected valve position in response to at least one of a change in set point and inlet pressure, wherein the expected valve position is not based on a signal provided by a thermal mass flow meter of the thermal mass flow controller; and
adjusting an adjustable valve to the expected valve position to control flow through the mass flow controller.

18. The method of claim 17, wherein calculating the expected valve position utilizes a mathematical model of valve involving a multivariable function.

19. The method of claim 17, wherein calculating the expected valve position includes deriving a magnetic force magnetically from the adjustable valve itself.

20. A computer program product embodied on a tangible computer readable medium having instructions thereon that when executed causes a thermal mass flow controller to:
determine an expected valve position in response to at least one of a change in set point and inlet pressure, wherein the expected valve position is not based on a signal provided by a thermal mass flow meter of the thermal mass flow controller;
adjust an adjustable valve to the expected valve position to control flow through the mass flow controller; and
compare the expected valve position to a second valve position based on a signal corresponding to mass flow provided by a thermal mass flow meter of the mass flow controller.
